(19) United States
(12) Patent Application Publication
(10) Pub. No.: US 2008/0291284 A1
(43) Pub. Date: Nov. 27, 2008

(54) COMMUNICATION DEVICE AND IMAGE TRANSMISSION METHOD

(75) Inventor: Erik Robsarve, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/753,833

(22) Filed: May 25, 2007

(51) Int. Cl. H04N 5/225

(52) U.S. Cl. 348/207.99

(57) ABSTRACT

The invention relates to a communication device adapted to transmit images having a resolution adapted to a desired part of a picture. In an aspect of the present invention, the user can select a part of the image to be transmitted with the message service. Only the selected part is compressed in dependence of maximum limit permitted to be sent. Preferably, the part of the image to be sent is compressed to the smallest possible extent. The present invention also relates to a corresponding transmission method.

### FIELD OF THE INVENTION

The present invention relates to a communication device adapted to transmit images having a resolution adapted to a desired part of a picture. The present invention also relates to a corresponding transmission method.

### BACKGROUND OF THE INVENTION

Communication devices such as mobile telephones are often equipped with cameras of high quality having high resolution resulting in large image sizes. The images may be shared with other users by transmission over a telecommunications network using a messaging service such as MMS, Multimedia Messaging Service, or SMS, Short Messages Service, or other formats, in which the image is enclosed. For example MMS, however, has limits on the transmitted image size, typically 320*240 pixels corresponding to a maximum limit of 76.8 Kbytes, assuming 1 byte (8 bits) per pixel which today is the standard for mobile communications. The limit depends on the number of bits per pixel, which may be 8, 16, 24, 48 bits per pixel. On the other hand the camera of the device often can use 1.3, 2.3 Mpixels or more for each image in order to take full advantage of the camera.

When such a large image is to be transmitted using MMS, the standard procedure is to compress the whole image from e.g. 2 MBytes to a lower resolution so that the image size is reduced. However, a reduction of the resolution from 2 MBytes to 76.8 Kbyte involves a lower resolution by a factor of approximately 26, thus in the worst case rendering the transmitted image unusable or undistinguishable.

### SUMMARY OF THE INVENTION

In an aspect of the present invention, the user can select a part of the image to be transmitted with the message service. Only the selected part is compressed in dependence of maximum limit permitted to be sent. Preferably, the part of the image to be sent is compressed to the smallest possible extent.

In a first aspect, the invention provides a communication device comprising:

a control unit for processing data files containing images stored in an internal or attachable memory;

a communication interface capable of transmitting images, a maximum limit being imposed on images to be transmitted;

a user interface including a display capable of showing images and input means for inputting commands; wherein

the control unit is adapted to process a data file to be transmitted containing an image by letting a user select a part of the data file; and transforming the selected part from the data file to a compressed size depending on the maximum limit.

In one embodiment, the control unit is adapted to receive the selection by letting the user perform a zooming and selection action on an image shown on the display.

The control unit may further be adapted to receive the selection by letting the user further perform a rotation of the image.

In a further embodiment, the control unit is adapted to show a frame imposed on an image shown on the display, and to receive the selection by letting the user position said frame.

Suitably, the frame can be rotated from a landscape to a portrait orientation and vice versa.

Suitably, the size of the frame can be changed.

In a still further embodiment, the control unit is adapted to make the selection by means of image recognition.

Suitably, the compressed size substantially equals the maximum limit.

Suitably, the transformation of the selected part is performed by means of compression coding.

The communication device may be a device from the group comprising: a portable radio communication equipment, a mobile radio terminal, a mobile telephone, a cellular telephone, a pager, a communicator, an electronic organizer, a smart phone, a digital camera, a digital media player, a portable game console, a GPS device or a computer.

In a second aspect, the invention provides an image transmission method for a communication device with a maximum limit being imposed on images to be transmitted, comprising:

selecting a part of the data file containing an image stored in an internal or attachable memory of the device;

transforming the selected part from the data file to a compressed data file with a size depending on the maximum limit;

transmitting the compressed data file.

In one embodiment, the selection includes a zooming and selection action on an image shown on a display of the communication device.

The selection may further include rotation of the image.

In a further embodiment, the selection includes showing a frame imposed on an image shown on a display of the communication device, and positioning of said frame.

The selection may include rotation of the frame from a landscape to a portrait orientation or vice versa.

The selection may include changing the size of the frame.

In a still further embodiment, the selection includes image recognition.

Suitably, the compressed size substantially equals the maximum limit.

Suitably, the transformation of the selected part is performed by means of compression coding.

### BRIEF DESCRIPTION OF THE DRAWINGS

Embodiments of the invention will be described below with reference to the accompanying drawings, in which:

FIG. 1 is a schematic view of a communication device according to the invention,

FIG. 2 is a block diagram of units of the communication device, and

FIG. 3 is a flow diagram of the image compression according to an embodiment of the invention.

### DETAILED DESCRIPTION OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. Furthermore, the terminology used in this specification is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The present description relates to the field of electronic devices including a digital camera or at least having the capacity of storing and forwarding images. The device may be portable radio communication equipment, a mobile radio terminal, a mobile telephone, a cellular telephone, a pager, a communicator, an electronic organizer, a smart phone, a digital camera, a digital media player, a portable game console, a GPS device or a computer.

A preferred embodiment of the invention relates to a portable communication device, such as a mobile telephone. For the sake of clarity and simplicity, most embodiments outlined herein are related to mobile phones. Preferred embodiments will now be described with reference to the accompanying drawings.

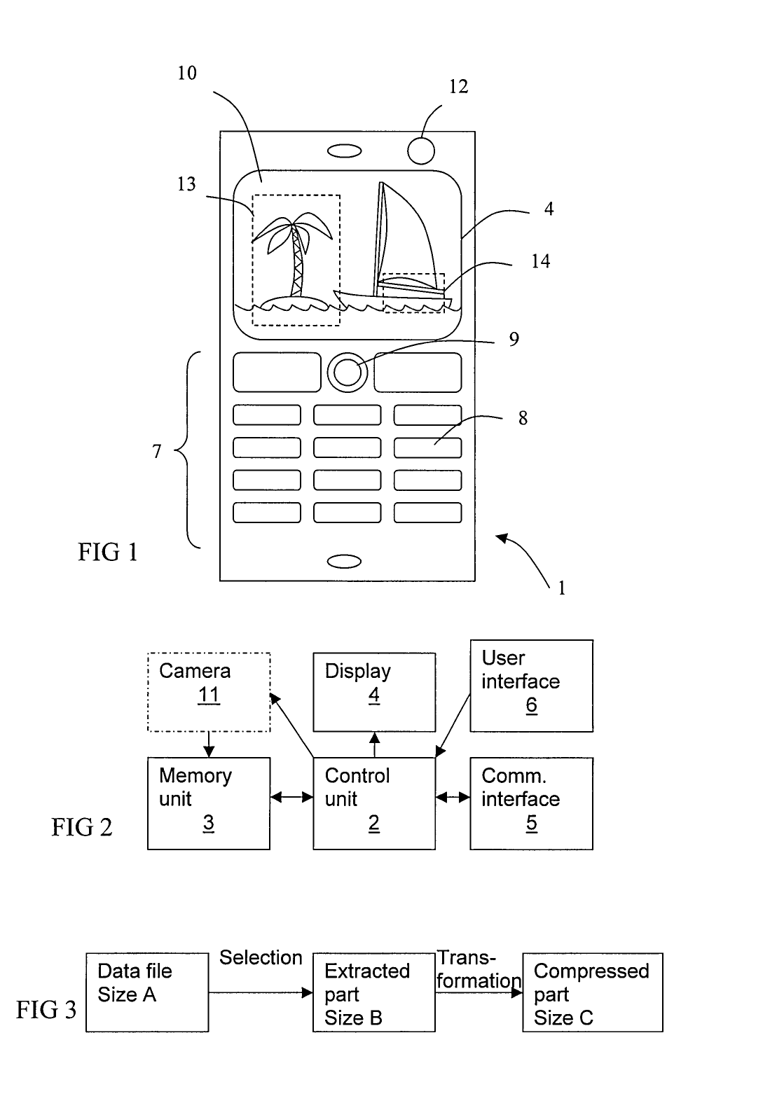

A communication device 1, configured in accordance with an embodiment of the invention is shown in FIG. 1. A block diagram of internal units of the device relevant to the present invention is shown in FIG. 2.

The communication device 1 comprises a display for showing images 10 and other information. A user can input commands through an input means 7 comprising buttons 8 and navigation means 9, suitably in a form of a joystick or the like. Suitably the device 1 also comprises a camera 11 provided with at least one lens, such as shown at 12. Often the main lens is provided on the other side so that the user may use the display 4 as a viewfinder.

Relevant units of the communication device are also shown in block diagram form in FIG. 2. A control unit 2 is adapted to control various functions of the device. The user interacts with the device through a user interface 6 comprising the input means 7 and the display 4. The communication device is arranged to communicate with other devices and telecommunications networks through a communication interface 5 as is known in the art. The device also comprises a memory unit 3 for storing images and other data. Images may also be stored in an attachable memory unit such as a memory card. The camera 11 produces images to be stored and shared with other users. The camera 11 and the process of taking pictures do not form part of the present invention per se.

When the user has taken a picture and stored it in the memory unit he may want to transmit the image to share it with another user. Using short range radio, such as with Bluetooth, or an infrared connection, this is generally no problem because there is no restriction on the file size to be transmitted. However, with a message service through the telecommunications network, such as MMS and SMS there is a maximum limit imposed by the operator. In the prior art, typically, the control unit checks the size of the image to be transmitted and issues a warning. A message will pop up on the display, for example “The image is too large. Reduce size?”. The user may respond to the warning by accepting the reduction and the whole image is reduced to a suitable size.

In the present invention a novel approach is used. The user is given an opportunity to select a part of the image and only this part is compressed, if necessary, and transmitted.

In an embodiment of the invention, after the user has selected an image to be transmitted, the control unit to checks the size and, if the image is too large to be transmitted directly, the control unit too issues a warning. For example, a message is popped up on the display such as, “The image is too large. Select part?” (If the user replies no, the user can still reduce the whole image as in the prior art.) If the user replies yes, the control unit 2 gives the user an option to select a part of the image.

In a first embodiment, the user is prompted to perform a zooming action in the image such that the part of the image shown on the display is the part selected to be compressed and transmitted. Zooming mechanisms are known in the prior art. For example, the user may press the joystick 9 to zoom stepwise or continuously and toggle the joystick up, down, to the left and to the right to move the part shown on the display. The display boundary marks the boundary of the selection. To finish, the user may press an OK button or the like.

Since the image and the display are generally not square but have a greater width than height (in landscape orientation), the user may first have the option to rotate the image 90 degrees. Thus, the user may for instance select a part shown within the dashed frames 13 or the dashed frame 14 using the zooming function.

In a further embodiment, the control unit 2 is adapted to show a frame over the image, such as the dashed frames 13 and 14. First the user selects one of the frames, such as frame 13 for portrait mode or frame 14 for landscape mode. Then the user is prompted to adjust the boundaries of the frame in order to select size and position. The selection may be made using the buttons 8 and the joystick 9 which have been assigned suitable functions. To finish, the user presses an OK button.

In a still further embodiment the control unit 2 is arranged to perform image recognition on the image in question. For instance, if the image contains a human face a frame is automatically positioned such that the selected part covers the face to produce a portrait.

Irrespective of how the selection was made, the selected part of the image corresponds to a part of the data file representing the whole image which is stored in the memory unit 3. FIG. 3 illustrates how the compressed part is produced. Originally the image is stored in the data file having size A. After the selection the selected part has a size B. The maximum limit imposed by the operator is stored in the device and the size B is compared to the maximum limit. If size B is greater than the maximum limit the extracted part has to be transformed to an even smaller size, size C. The control unit processes the selected part and transforms it to a new, compressed part having size C. The compressed part is copied to memory for later transmission or just transmitted directly. Typically, a copy of the compressed part is enclosed with a message using MMS or SMS.

Suitably, size C substantially equals the maximum limit associated with the selected transmission service, typically MMS or SMS. Different maximum limits may be associated with different transmission services.

Various embodiments of the present invention have been outlined above and specific examples have been described in detail with reference to the appended drawings. It should be noted, though, that the invention is not limited to these specific examples, but may in fact be modified within the scope defined by the appended claims.

1. A communication device comprising:
a control unit for processing data files containing images stored in an internal or attachable memory;
a communication interface capable of transmitting images, a maximum limit being imposed on images to be transmitted;
a user interface including a display capable of showing images and input means for inputting commands; wherein
the control unit is adapted to process a data file to be transmitted containing an image by letting a user select a part of the data file; and transforming the selected part from the data file to a compressed size depending on the maximum limit.

2. A communication device as claimed in claim 1, wherein the control unit is adapted to receive the selection by letting the user perform a zoom and selection action on an image shown on the display.

3. A communication device as claimed in claim 2, wherein the control unit is adapted to receive the selection by letting the user further perform a rotation of the image.

4. A communication device as claimed in claim 1, wherein the control unit is adapted to show a frame imposed on an image shown on the display, and to receive the selection by letting the user position said frame.

5. A communication device as claimed in claim 4, wherein the frame can be rotated from a landscape to a portrait orientation and vice versa.

6. A communication device as claimed in claim 4, wherein the size of the frame can be changed.

7. A communication device as claimed in claim 1, wherein the control unit is adapted to make the selection by means of image recognition.

8. A communication device as claimed in claim 1, wherein the compressed size substantially equals the maximum limit.

9. A communication device as claimed in claim 1, wherein the transformation of the selected part is performed by means of compression coding.

10. A communication device as claimed in claim 1, wherein the communication device is a device from the group comprising: a portable radio communication equipment, a mobile radio terminal, a mobile telephone, a cellular telephone, a pager, a communicator, an electronic organizer, a smart phone, a digital camera, a digital media player, a portable game console, a GPS device or a computer.

11. An image transmission method for a communication device with a maximum limit being imposed on images to be transmitted, comprising:
selecting a part of the data file containing an image stored in an internal or attachable memory of the device;
transforming the selected part from the data file to a compressed data file with a size depending on the maximum limit;
transmitting the compressed data file.

12. An image transmission method as claimed in claim 11, wherein the selection includes a zoom and selection action on an image shown on a display of the communication device.

13. An image transmission method as claimed in claim 12, wherein the selection further includes rotation of the image.

14. An image transmission method as claimed in claim 11, wherein the selection includes showing a frame imposed on an image shown on a display of the communication device, and positioning of said frame.

15. An image transmission method as claimed in claim 14, wherein the selection includes rotation of the frame from a landscape to a portrait orientation or vice versa.

16. An image transmission method as claimed in claim 14, wherein the selection includes changing the size of the frame.

17. An image transmission method as claimed in claim 14, wherein the selection includes image recognition.

18. An image transmission method as claimed in claim 11, wherein the compressed size substantially equals the maximum limit.

19. An image transmission method as claimed in claim 11, wherein the transformation of the selected part is performed by means of compression coding.
